(19) United States
(12) Patent Application Publication
(10) Pub. No.: US 2006/0150589 A1
(43) Pub. Date: Jul. 13, 2006

(54) Filter removal handle

(76) Inventor: Marvin Shepard Crow, Lorton, VA (US)

Correspondence Address: MARVIN SHEPARD CROW, 5913 RIVER DRIVE, LORTON, VA, 22079, US

(21) Appl. No.: 11/031,082

(22) Filed: Jan. 10, 2005

(51) Int. Cl. B01D 46/00

(52) U.S. Cl. 55/357

(57) ABSTRACT

The invention of adding a handle to air filters is unique since an exhaustive search of air filters has revealed that no existing filters on the market today are so equiped.

### BACKGROUND OF THE INVENTION

This invention pertains to air filters contained in various items of equipment that require air filtration. Equipment such as airconditioners, furnaces, airhandlers and heat pumps use air filters. This invention solves the problem of removing air filters from the prior listed equipment, without bending or crushing them.

### BRIEF SUMMARY OF THE INVENTION

This invention adds a handle to the filters, in the above listed equipment, to allow homeowners and maintenance personnel to easily remove the filters from their mount.

### BRIEF DESCRIPTION OF THE SEVERAL VIEWS OF THE DRAWINGS

FIG. 1 A depicts the side view of the Filter Removal Handle

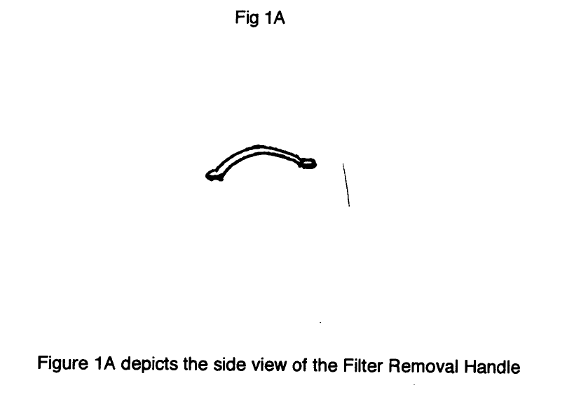

FIG. 1 B depicts the top view of the Filter Removal Handle

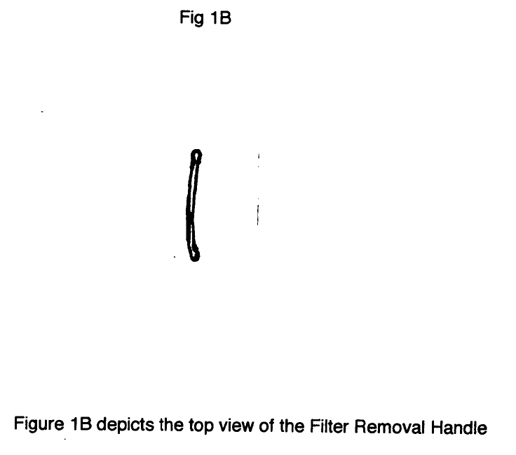

FIG. 2A depicts the handle location on the side of a Square Filter.

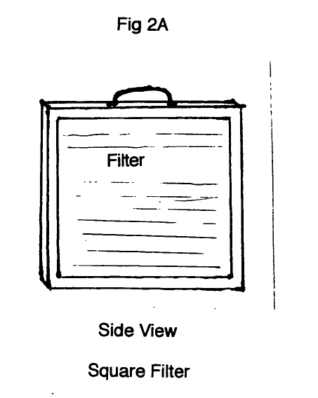

FIG. 2B depicts the handle location on the end of a Square Filter.

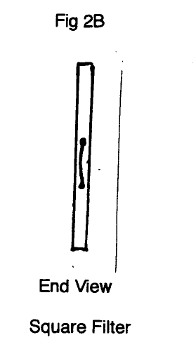

FIG. 3A depicts the optional handle locations on the sides of a Rectangular Filter.

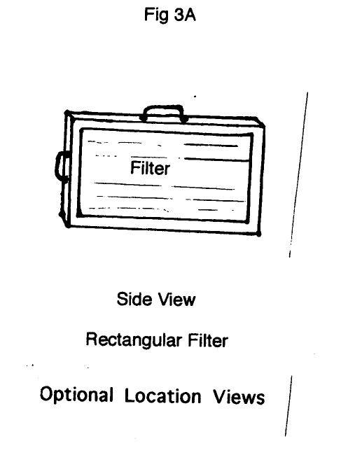

FIG. 3B depicts the handle location on the short end of a Rectangular Filter.

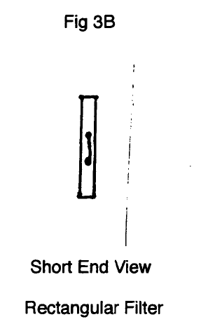

FIG. 3C depicts the handle location on the long end of the Rectangular Filter.

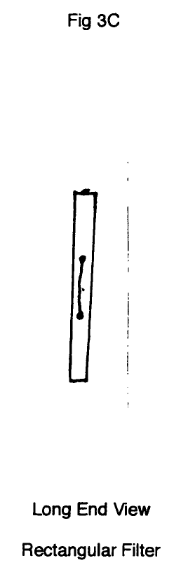

### DETAILED DESCRIPTION OF THE INVENTION

This invention adds a handle to air filters that will assist homeowners and maintenance personnel while removing filters from airconditioners, furnaces, airhandlers and heat pumps. The handles should be made of plastic cord, string, heavy cardboard strip, thin metal strip or light wire. As shown in the accompanying drawings, the handles should be attached to the filter with glue, rivets, screws or staples, when the filter is assembled, centering the handle on one edge of the square filter and the long and short edge of the rectangular filter. The flexible handle should be 4 to 6 inches in length, no more than ½ inch in width, no more than ¼ inch thick and should be allowed to rise no more than ½ inch from the filter frame. The handle should be placed on the outside edge when the filter is installed in the filter mount and must be properly placed on the filter frame to account for the required direction of air flow. When the filter requires changing, it can be very easily removed from its mount by pulling on the handle and extracting the filter, without bending or crushing the filter.

What I claim as my invention is:

1. The addition of a handle to air filters to allow easy removal of the filter from its mount in equipment that requires an air filter of these types.
